(19) United States
(12) Patent Application Publication
(10) Pub. No.: US 2023/0325683 A1
(43) Pub. Date: Oct. 12, 2023

(54) AUTOMATICALLY ASSESSING ALERT RISK LEVEL

(71) Applicant: Wells Fargo Bank, N.A., San Francisco, CA (US)

(72) Inventors: Daniel Jeffery Johnson, Milwaukee, WI (US); Ramon Joseph Permato Esteves, Baliuag, Bulacan (PH)

(21) Appl. No.: 16/447,567

(22) Filed: Jun. 20, 2019

(51) Int. Cl. G06N 5/02; G06Q 10/06; G06F 21/31

(52) U.S. Cl. CPC G06N 5/022; G06Q 10/06393; G06F 21/316; G06Q 10/06398; G06F 9/542

(57) ABSTRACT

Techniques are described for automatically assessing alert risk. An example computing device configured to perform the techniques receives an alert representing a type of abnormal behavior for a user account. The computing device receives a domain knowledge score for the alert, the domain knowledge score representing a qualitative rating assigned by one or more subject matter experts; determines a machine knowledge score for the alert, the machine knowledge score representing a number of positive alerts for the type of abnormal behavior; and calculates an overall score for the alert from the domain knowledge score and the machine knowledge score. The computing device determines whether the overall score indicates that the alert represents a positive alert or a false positive alert for the type of abnormal behavior. The computing device may further output data representative of the alert to a user when the alert is determined to be the positive alert.

### TECHNICAL FIELD

This disclosure relates to computer systems that receive and process security alerts.

### BACKGROUND

In various industries and processes, customers and other actors tend to act within a range of expected behaviors. In some cases, actions outside of the range of expected behaviors can be seen as anomalous, which may indicate a heightened security risk. That is, when an actor takes an action that is not within the range of expected behaviors, the action may indicate that the actor is acting in a way that might be seen as malicious. Thus, computer systems and users involved in security may further analyze the actor and the action to determine whether the actor is behaving maliciously. For example, computer systems may output alerts representing the actor and the action to be reviewed by the users.

### SUMMARY

In general, this disclosure describes techniques for automatically assessing alert risk level. In particular, when a central device (e.g., a central system of record) receives an alert from other devices in a computer system, the central device may determine whether or not the alert represents an actionable alert, i.e., an alert requiring further action. In particular, the central device may calculate an overall score for an alert from both a domain knowledge score and a machine knowledge score. The domain knowledge score may represent a qualitative rating of the alert determined by risk subject matter experts within a consumer control organization. The machine knowledge score may represent a percent of closed alerts having a positive alert (e.g., a disposition other than “no findings”) and provide a true positive rating by detection strategy for historical alerts. The central device may calculate the score from a domain weight (DW) applied to the domain knowledge (DK) score and a machine weight (MW) applied to the machine knowledge (MK) score, e.g., score=(DW*DK)+(MW*MK).

In one example, a method includes receiving, by a processor implemented in circuitry, an alert representing a type of abnormal behavior for a user account; receiving, by the processor, a domain knowledge score for the alert, the domain knowledge score representing a qualitative rating assigned by one or more subject matter experts; determining, by the processor, a machine knowledge score for the alert, the machine knowledge score representing a number of positive alerts for the type of abnormal behavior; calculating, by the processor, an overall score for the alert from the domain knowledge score and the machine knowledge score; and determining, by the processor, whether the overall score indicates that the alert represents a positive alert or a false positive alert for the type of abnormal behavior

In another example, a device includes a processor implemented in circuitry and configured to: receive an alert representing a type of abnormal behavior for a user account; receive a domain knowledge score for the alert, the domain knowledge score representing a qualitative rating assigned by one or more subject matter experts; determine a machine knowledge score for the alert, the machine knowledge score representing a number of positive alerts for the type of abnormal behavior; calculate an overall score for the alert from the domain knowledge score and the machine knowledge score; and determine whether the overall score indicates that the alert represents a positive alert or a false positive alert for the type of abnormal behavior.

In another example, a computer-readable medium, such as a computer-readable storage medium, has stored thereon instructions that, when executed, cause a processor to receive an alert representing a type of abnormal behavior for a user account; receive a domain knowledge score for the alert, the domain knowledge score representing a qualitative rating assigned by one or more subject matter experts; determine a machine knowledge score for the alert, the machine knowledge score representing a number of positive alerts for the type of abnormal behavior; calculate an overall score for the alert from the domain knowledge score and the machine knowledge score; and determine whether the overall score indicates that the alert represents a positive alert or a false positive alert for the type of abnormal behavior.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing system configured to determine riskiness of an alert according to the techniques of this disclosure.

FIG. 2 is a block diagram illustrating an example set of components of a central device configured to perform the techniques of this disclosure.

FIG. 3 is a flowchart illustrating an example method of calculating a score for an alert and for analyzing scores for alerts according to the techniques of this disclosure.

FIG. 4 is a graph illustrating an example of a total volume and a risk-weighted volume of alerts for three branches of an example enterprise business.

FIG. 5 is a flowchart illustrating a graph of alert volume by high, medium, and low categories per branch for three branches of an example enterprise business.

FIG. 6 is a pair of graphs illustrating an inverted percentage of total alerts and a base 3 weighting scheme according to the techniques of this disclosure.

### DETAILED DESCRIPTION

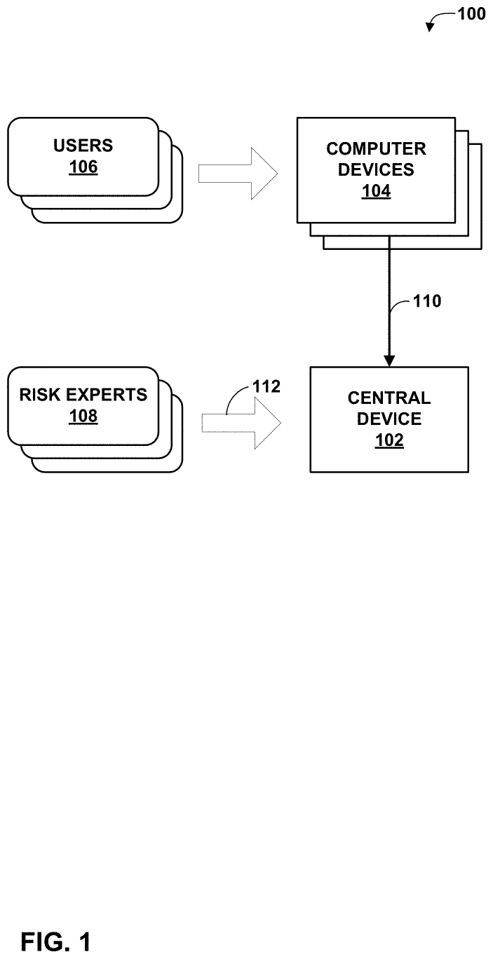

FIG. 1 is a block diagram illustrating an example computing system 100 that may determine riskiness of an alert according to the techniques of this disclosure. In particular, system 100 includes computer devices 104 and central device 102. Computer devices 104 represent examples of various types of computers that may be used by users 106, e.g., for performing tasks for customers. Central device 102 represents an example of a central system of record that receives alerts 110 and, according to the techniques of this disclosure, automatically determines riskiness of alerts 110 (e.g., whether or not the alerts merit further action). When an alert merits further action, central device 102 may perform the action or output data representing the alert and an indication that the alert requires further action, as explained in greater detail below.

In general, users 106 (who may be employees of a business enterprise, such as a bank or other business) may assist customers with various transactions. For example, for a bank, a customer may open an account, add or withdraw funds to or from an account, open a line of credit or credit card, close an account, or the like. In some instances, users 106 may determine that a transaction performed by a customer or potential customer represents an anomalous or abnormal behavior. For instance, not funding a new checking or savings account, performing a transaction that overdraws an account, or other such abnormal behaviors may merit an alert. In response, one of users 106 may issue one of alerts 110 via a respective one of computer devices 104 to central device 102. In some examples, users 106 may issue alerts to central device 102 using respective computer devices 104 via an enterprise access portal.

Central device 102, according to the techniques of this disclosure, may calculate riskiness scores for alerts 110 received from computer devices 104. In particular, central device 102 may calculate a score using both a domain knowledge score and a machine knowledge score. Risk experts 108 represent risk subject matter experts who can provide an objective evaluation of risk for various alerts of abnormal user behaviors. In the example of FIG. 1, risk experts 108 provide domain knowledge scores 112 for alerts 110.

Central device 102 also uses a machine knowledge score when calculating a score for one of risks 110. In general, the machine knowledge score represents a percent of previously closed alerts having a positive alert, e.g., a disposition other than “no findings.” That is, the machine knowledge score represents the number of previously analyzed alerts for which some further action was required, i.e., positive alerts as opposed to false positive alerts. In some examples, the machine knowledge alert is determined from previous alerts of the same type as the alert currently being analyzed. For instance, if the current alert was for an unfunded new account, the previous alerts used to determine the machine knowledge score may also be for alerts for unfunded new accounts.

In general, central device 102 may calculate a score, e.g., a riskiness score, for an alert from both the domain knowledge score and the machine knowledge score. In some examples, central device 102 may weight the domain knowledge score and the machine knowledge score with respective weights, e.g., a domain weight and a machine weight, respectively. In some examples, the domain weight and the machine weight may be rational number values in the range from 0 to 1, and the sum of the domain weight and the machine weight may be equal to 1. Thus, for example, the domain weight may be 0.3 and the machine weight may be 0.7. In some examples, as explained in greater detail below, central device 102 may select the domain weight as a base three exponential value, e.g., one of 3⁰(1, i.e., 11%), 3¹ (3, i.e., 33%), or 3² (9, i.e., 100%). Thus, central device 102 may select the machine weight as the difference between 1 and the domain weight, e.g., 89%, 67%, or 0%.

Central device 102 may calculate the actual riskiness score for an alert by applying the domain weight to the domain knowledge score and the machine weight to the machine knowledge score. For example, central device 102 may calculate the actual riskiness score according to the following formula:

score=(DK*DW)+(MK*MW) (1)

where DK is the domain knowledge score, DW is the domain weight, MK is the machine knowledge score, and MW is the machine weight.

After having calculated a score for an alert, central device 102 may determine whether the alert requires further action. For example, central device 102 may determine whether the score for an alert is above a pre-determined threshold. If the score is above the threshold, central device 102 may determine that the alert is a positive alert, whereas if the score is not above the threshold (i.e., below the threshold), central device 102 may determine that the alert is a false positive alert.

Over time, central device 102 may receive alerts from a variety of sources, such as particular users 106 (e.g., employees) and computer devices 104. Moreover, users 106 and computer devices 104 may be geographically located in various locations, such as at various business branch offices, which may be in a variety of different business regions. Such regions may include, for example, different cities, counties, states, groups of nearby states, or countries. Thus, after accumulating alerts from a variety of such sources, central device 102 may determine an overall riskiness of each source at a variety of granularities. For example, central device 102 may determine overall riskiness of individual employees, branches, or regions.

Central device 102 may then compare scores for alerts generated by entities at similar granularities of the business enterprise. That is, central device 102 may group employees, branches, or regions, and compare members of these groups to each other. For example, central device 102 may compare scores for employees, branches, or regions to each other. Central device 102 may provide comparison data to business officers or executives, who may use this data to determine whether certain employees, branches, or regions should receive further coaching or training on when to or not to issue an alert for particular customer actions.

Over time, central device 102 may also modify the weights applied to alerts. For example, over time, central device 102 may decrease the domain weight and correspondingly increase the machine weight. As one example, central device 102 may decrease the domain weight from 100% to 33% to 11%, and correspondingly increase the machine weight from 0% to 67% to 89%. An administrator may determine when such modifications to the weights are to be applied and submit configuration instructions to central device 102 to update the weights accordingly. For example, the administrator may update the weights on a periodic schedule, e.g., monthly or quarterly. Additionally or alternatively, central device 102 may adjust the weights as a function of a number of alerts received. For example, when a number of alerts reaches a first threshold, central device 102 may perform a first weight adjustment, and when the number of alerts reaches a second threshold, central device 102 may perform a second weight adjustment.

In this manner, the techniques performed by central device 102 may generally improve performance of central device 102, computer devices 104, and system 100, as well as other similar systems, thereby improving the field of transaction monitoring and alert analysis. For example, analysis of alerts may be improved through updating the machine knowledge and training of employees. Thus, the amount of manual intervention required by, e.g., risk experts 108, may be reduced. Likewise, these techniques provide relative rankings of alerts from sources at similar levels of organizational granularity. Thus, deviations from the norm for various sources can be identified, to provide training as needed, and thereby further improve the quality of alerts, which may reduce the amount of false positive alerts needing to be identified by central device 102, thereby improving the performance of central device 102 and computer devices 104.

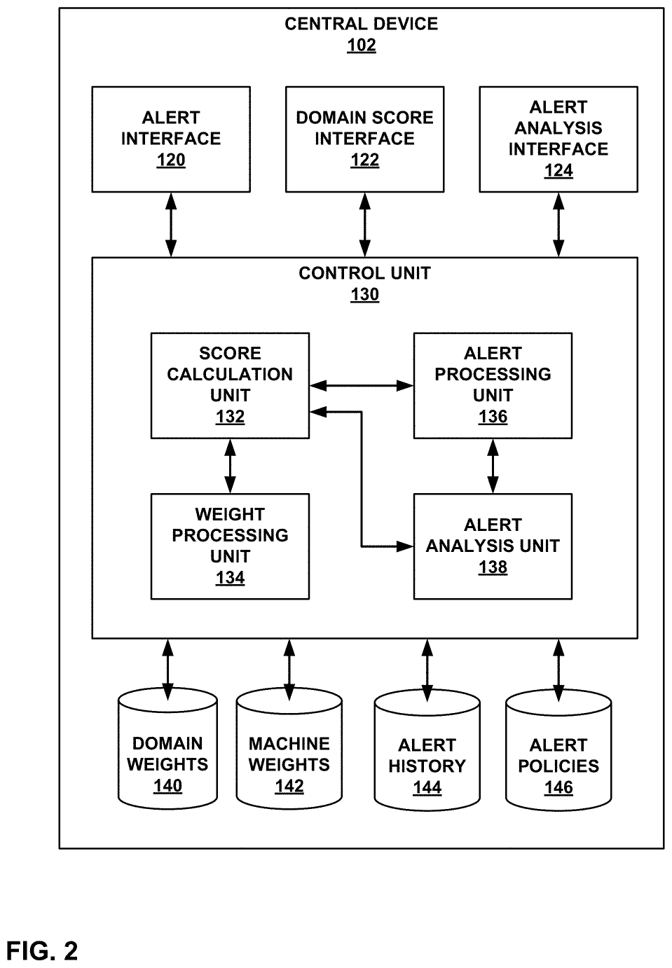

FIG. 2 is a block diagram illustrating an example set of components of central device 102 of FIG. 1, which may be configured to perform the techniques of this disclosure. In the example of FIG. 2, central device 102 includes alert interface 120, domain score interface 122, control unit 130, domain weights database 140, machine weights database 142, alert history database 144, and alert policies database 146. Control unit 130 further includes score calculation unit 132, weight processing unit 134, alert processing unit 136, and alert analysis unit 138.

Domain weights database 140, machine weights database 142, alert history database 144, and alert policies database 146 represent one or more respective computer-readable storage media, which may be included within central device 102 as shown in the example of FIG. 2. Alternatively, one or more of domain weights database 140, machine weights database 142, alert history database 144, and alert policies database 146 may be stored in a remote device (not shown) to which central device 102 may be communicatively coupled. The computer-readable storage media may be one or more of a hard disk, a flash drive, random access memory (RAM), or other such computer-readable storage media.

Alert interface 120, domain score interface 122, and alert analysis interface 124 represent interfaces for receiving alerts and domain scores, and for receiving requests for and providing analytical data of alerts, respectively. For example, alert interface 120, domain score interface 122, and alert analysis interface 124 may represent one or more of a network interface, user interfaces (e.g., a keyboard, mouse, touchscreen, command line interface, graphical user interface (GUI), or the like), monitors or other display devices, or other such interfaces for receiving input from and providing output to users and other computing devices either directly or remotely. In accordance with the techniques of this disclosure, central device 102 receives alerts 110 from computer devices 104 of FIG. 1 via alert interface 120, and domain knowledge scores 112 from risk experts 108 via domain score interface 122. Likewise, central device 102 may receive requests for alert analytics and provide data representing such analytics via alert analysis interface 124.

Control unit 130 represents one or more hardware-based processing units implemented in circuitry. For example, control unit 130 and the components thereof (e.g., score calculation unit 132, weight processing unit 134, alert processing unit 136, and alert analysis unit 138) may represent any of one or more processing units, such as microprocessors, digital signal processors (DSPs), field programmable gate arrays (FPGAs), application specific integrated circuits (ASICs), or other such fixed function and/or programmable processing elements. Control unit 130 may further include a memory for storing software and/or firmware instructions to be executed by the processing units thereof. Thus, the functionality of control unit 130, score calculation unit 132, weight processing unit 134, alert processing unit 136, and alert analysis unit 138 may be implemented in any combination of hardware, software, and/or firmware, where software and firmware instructions may be executed by hardware-based processing units implemented in circuitry.

In accordance with the techniques of this disclosure, score calculation unit 132 calculates scores for alerts received via alert interface 120. Score calculation unit 132 may calculate such scores using both a domain knowledge score and a machine knowledge score. Score calculation unit 132 may receive a domain knowledge score from domain score interface 122. Likewise, score calculation unit 132 may determine a machine knowledge score from alert history 144. That is, as noted above, the machine knowledge score may represent a number of positive alerts, that is, alerts resulting in a disposition other than “no findings,” i.e., non-false positive alerts. In some examples, the machine knowledge score may be numbers of positive alerts for the type of abnormal behavior corresponding to the type of abnormal behavior that triggered the alert being analyzed. Score calculation unit 132 may determine the number of positive alerts from alert history 144, which stores data representing alerts and dispositions for the alerts (e.g., no disposition or other actions taken for previously processed alerts).

Additionally, weight processing unit 134 may access data of domain weights database 140 and machine weights database 142. For example, score calculation unit 132 may calculate a score for an alert according to formula (1) above (i.e., domain weight (DW) times domain knowledge score (DK) plus machine weight (MW) times machine knowledge score (MK)). Weight processing unit 134 may retrieve the current domain weight and the current machine weight from domain weights database 140 and machine weights database 142, respectively. Furthermore, weight processing unit 134 may update current domain weights and machine weights in domain weights database 140 and machine weights database 142, respectively, over time, e.g., at the direction of an administrator and/or automatically, e.g., as a number of alerts stored in alert history 144 increases.

In some examples, domain weights database 140 may store a set of potential domain weights, which may be base three values representing weights of 0.11, 0.33, and 1.00, respectively. Machine weights database 142 may store corresponding potential machine weights of 0.89, 0.67, and 0.00, respectively. Additionally, pointers or other data structures or data elements may have values representing a current domain weight of domain weights database 140 and a current machine weight of machine weights database 142. Thus, weight processing unit 134 may update the values of the pointers or other data structures when the weights are updated.

After score calculation unit 132 calculates a score for an alert, score calculation unit 132 may provide the score and data representative of the alert to alert processing unit 136 and alert analysis unit 138. Alert processing unit 136 may generally determine a disposition for the alert based on the score. For example, alert processing unit 136 may compare the score to a threshold to determine whether the alert is a positive alert or a false positive alert. If the alert is a positive alert, alert processing unit 136 may determine a disposition for the alert from alert policies 146. For example, the disposition may be to forward the alert to an administrator, to issue data to one of computer devices 104 to prevent or reverse a particular action (e.g., close an account or prevent an account from opening, prevent a transaction from occurring on an account, or the like), or other such actions. If the alert is a false positive alert, alert processing unit 136 may determine that the disposition is “no findings,” and no further action need be taken for the alert.

Additionally, alert processing unit 136 provides the alert disposition to alert analysis unit 138. Alert analysis unit 138 may store the disposition for the alert, the score for the alert, and contextual data regarding the alert (e.g., a user who triggered the alert, a branch and a region from which the alert originated, a client behavior or action that triggered the alert, or the like) to alert history 144.

Alert analysis unit 138 may compare alerts, scores for alerts, and dispositions for alerts among entities within a corresponding business enterprise at a similar level of granularity. For example, alert analysis unit 138 may compare alerts issued by users, branches, regions, or the like to each other. In this manner, alert analysis unit 138 may detect trends in alerts, identify outliers among peer groups regarding alerts, or the like, e.g., to determine whether additional training should be provided to members of certain branches or regions.

In this manner, central device 102 represents an example of a device comprising a processor implemented in circuitry and configured to receive an alert representing a type of abnormal behavior for a user account; receive a domain knowledge score for the alert, the domain knowledge score representing a qualitative rating assigned by one or more subject matter experts; determine a machine knowledge score for the alert, the machine knowledge score representing a number of positive alerts for the type of abnormal behavior; calculate an overall score for the alert from the domain knowledge score and the machine knowledge score; and determine whether the overall score indicates that the alert represents a positive alert or a false positive alert for the type of abnormal behavior. Additionally, to calculate the overall score for the alert, central device 102 may determine a domain weight to apply to the domain knowledge score, determine a machine weight to apply to the machine knowledge score, and calculate the overall score as a sum of the domain weight multiplied by the domain knowledge score and the machine weight multiplied by the machine knowledge score. Moreover, assuming the alert represents one alert of a plurality of alerts from a single source, central device 102 may be configured to calculate respective scores for each of the plurality of alerts using respective domain knowledge scores and respective machine knowledge scores, and determine a riskiness of the single source using the respective scores.

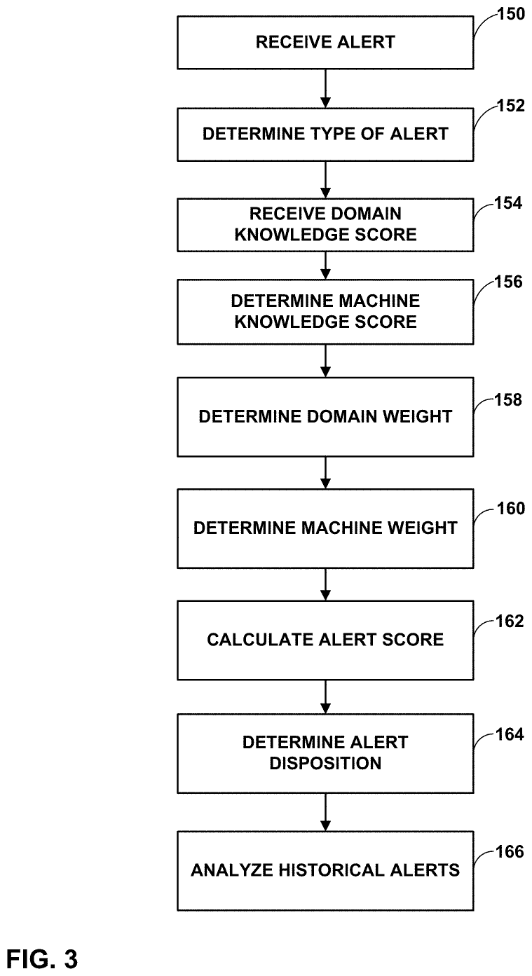

FIG. 3 is a flowchart illustrating an example method of calculating a score for an alert and for analyzing scores for alerts according to the techniques of this disclosure. For purposes of example and explanation, the method of FIG. 3 is explained with respect to central device 102 of FIGS. 1 and 2. However, it should be understood that other computer devices may be configured to perform this or a similar method.

Initially, central device 102 may receive an alert (150) via alert interface 120. Control unit 130 may then determine a type of the alert (152), e.g., a client behavior that caused the alert to be generated. Control unit 130 may also receive other contextual data for the alert, such as a user (e.g., employee) who entered the alert, a branch and region from which the alert originated, or the like.

Central device 102 may then prompt risk experts 108 to provide a domain knowledge score for the alert. For example, central device 102 may output data representative of the alert and the client behavior that caused the alert, and request that one or more of risk experts 108 provide a domain knowledge score for the alert based on this information. In response, central device 102 may receive a domain knowledge score (154) for the alert via domain score interface 122.

Control unit 130 may also determine a machine knowledge score (156) for the alert using data of alert history 144. For example, control unit 130 may determine a number of previous alerts (which may be all alerts or only alerts of the same type as the current alert) stored in alert history 144 which were positive alerts, i.e., had a disposition other than “no findings.”

Weight processing unit 134 may then determine a current domain weight (158) and a current machine weight (160). For example, weight processing unit 134 may retrieve the domain weight from domain weights database 140 and the current machine weight from machine weights database 142.

Score calculation unit 132 may then calculate a score for the alert (162). For example, score calculation unit 132 may execute formula (1) above to calculate the score. That is, score calculation unit 132 may multiply the domain weight by the domain knowledge score and the machine weight by the machine knowledge score, then add the resulting products together to produce the final risk score for the alert.

Alert processing unit 136 may then determine a disposition for the alert (164). For example, alert processing unit 136 may determine whether the score indicates that the alert is a positive alert or a false positive alert, e.g., due to one or more policies of alert policies database 146. If none of the policies indicate that a further action needs to be taken for the alert based on the score, alert processing unit 136 may determine that the disposition for the alert is “no findings,” and therefore, determine that the alert is a false positive alert. On the other hand, if one or more of the policies indicate that further action is required for the alert, control unit 130 may perform the action and/or output data to an appropriate entity who is responsible for performing the action. Additionally, control unit 130 may record data representing the alert, the calculated score for the alert, and the contextual data for the alert (e.g., the user, branch, and region from which the alert originated and the client behavior that triggered the alert) in alert history database 144.

After recording multiple alerts in alert history database 144, alert analysis unit 138 may analyze historical alerts of alert history database 144 (166). For example, alert analysis unit 138 may compare alerts and scores for the alerts among peer entities at a similar level of granularity within the enterprise business to each other. That is, alert analysis unit 138 may compare alerts and scores for the alerts from users, branches, or regions to each other, to determine if any of the branches or regions are particularly risky and/or if any of the users should be offered additional training. Moreover, the scores may indicate a relative severity of alerts originating from particular branches or regions, e.g., whether one or more branches or regions has a relatively abnormal number of alerts of low, medium, and/or high importance.

In this manner, the method of FIG. 3 represents an example of a method including receiving, by a processor implemented in circuitry, an alert representing a type of abnormal behavior for a user account; receiving, by the processor, a domain knowledge score for the alert, the domain knowledge score representing a qualitative rating assigned by one or more subject matter experts; determining, by the processor, a machine knowledge score for the alert, the machine knowledge score representing a number of positive alerts for the type of abnormal behavior; calculating, by the processor, an overall score for the alert from the domain knowledge score and the machine knowledge score; and determining, by the processor, whether the overall score indicates that the alert represents a positive alert or a false positive alert for the type of abnormal behavior. Calculating the overall score may include determining a domain weight to apply to the domain knowledge score, determining a machine weight to apply to the machine knowledge score, and calculating the overall score as a sum of the domain weight multiplied by the domain knowledge score and the machine weight multiplied by the machine knowledge score. The alert may be one of a plurality of alerts from a single source, and thus, the method may further include calculating respective scores for each of the plurality of alerts using respective domain knowledge scores and respective machine knowledge scores, and determining a riskiness of the single source using the respective scores.

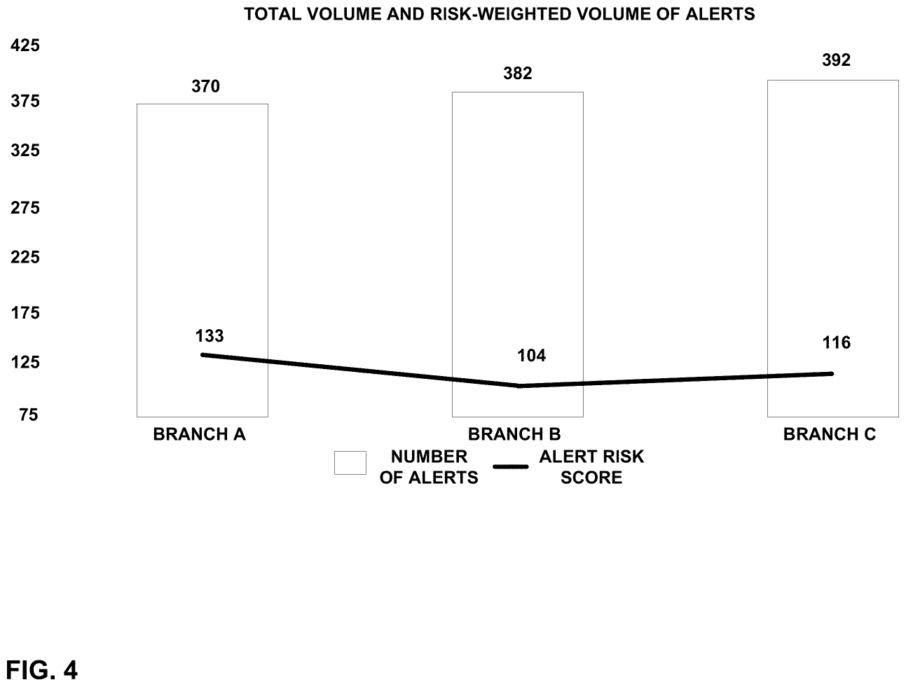

FIG. 4 is a graph illustrating an example of a total volume and a risk-weighted volume of alerts for three branches of an example enterprise business. The graph of FIG. 4 represents data for alerts for Branches A, B, and C of the example enterprise business. The graph includes bars for total alert volume and lines for risk-weighted volume of alerts according to the techniques of this disclosure.

In this example, 370 alerts originated from Branch A, 382 alerts originated from Branch B, and 392 alerts originated from Branch C. Without risk-weighting, it would appear that Branch C issued the most alerts and Branch A issued the fewest. That is, Branches B and C may be flagged as having elevated volumes of alerts. However, by applying the techniques of this disclosure, the risk-weighted alert score risk for Branch A is 133, the risk-weighted alert score risk for Branch B is 104, and the risk-weighted alert score risk for Branch C is 116. Thus, in reality, Branch A has the highest alert risk score, and Branch B has the lowest alert risk score, in this example.

Accordingly, an executive or officer of the enterprise business, in this example, may determine to offer employees of Branch C training on when it is appropriate to issue alerts, because there may be a relatively high number of false positive alerts originating from Branch C. Additionally or alternatively, because Branch A has the highest alert score risk, Branch A may be flagged as having an elevated score.

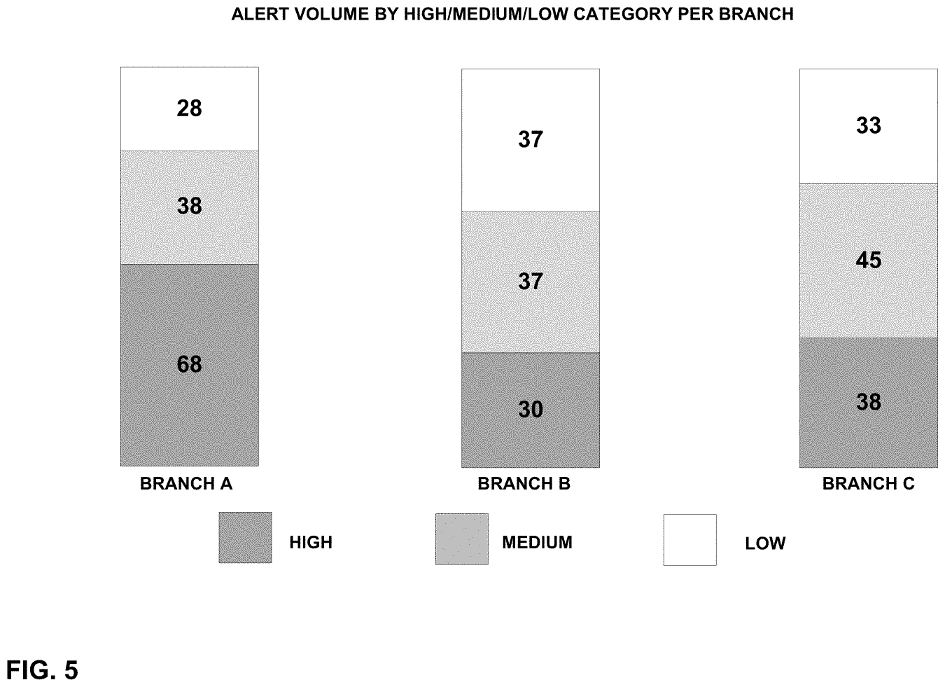

FIG. 5 is a graph illustrating an example of alert volume by high, medium, and low categories per branch for three branches of an example enterprise business. In this example, Branch A has 68 high category alerts, 38 medium category alerts, and 28 low category alerts; Branch B has 30 high category alerts, 37 medium category alerts, and 37 low category alerts; and Branch C has 38 high category alerts, 45 medium category alerts, and 33 low category alerts. Although Branch A in this example has the lowest alert volume, the majority of alerts in this example from Branch A are in the “high” category, leading to the higher risk weighted volume of FIG. 4.

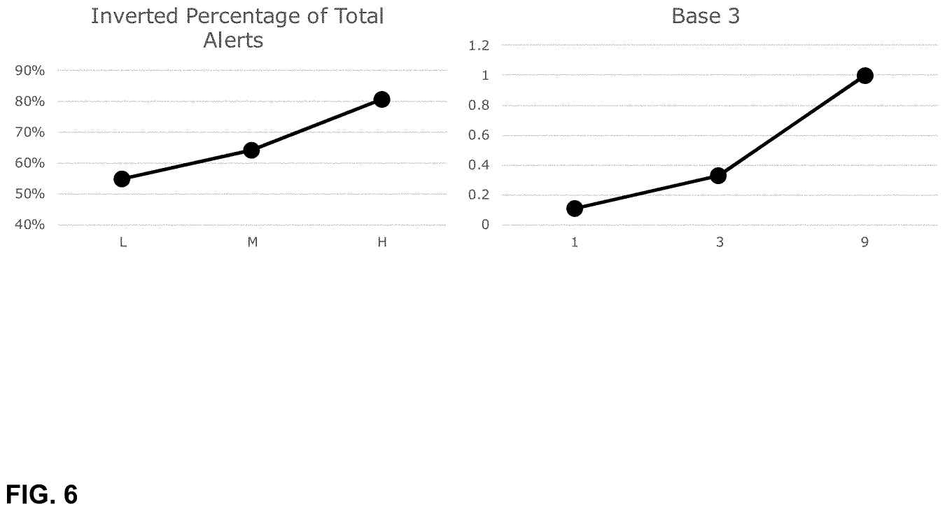

FIG. 6 is a pair of graphs illustrating an inverted percentage of total alerts and a base 3 weighting scheme according to the techniques of this disclosure. Central device 102 may normalize risk scores using the weighting scheme of FIG. 6. In general, the normalized data may be in the range of 0 to 1 in scale. The machine weight may be on a scale of 0 to 1 based on a coaching rate (0% to 100%), expressed as a decimal value. The coaching rate represents a number of alerts for which some corrective action was taken. Thus, the domain knowledge may be calculated using a base 3 exponential weighting based on alert distribution. For example, as noted above, 3° may represent a weight of 11%, 31 may represent a weight of 33%, and 32 may represent a weight of 100%, as shown in the Base 3 graph of FIG. 6. The inverted percentage of total alerts represents heuristic data measured for alerts over a trial period. As can be seen, the slopes of the two graphs are roughly equal, indicating validity of the selected domain weights of 11%, 33%, and 100%. The weightings may be selected to ensure that high volume, low alert generators are not overlooked relative to low volume, high alert generators.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

Various examples have been described. These and other examples are within the scope of the following claims.

1. A method comprising:
receiving, by a processor implemented in circuitry, an alert representing a type of abnormal behavior for a user account, the type of abnormal behavior being a type of behavior performed by a user associated with the user account that is abnormal relative to types of behaviors of other users with respect to respective accounts for the other users;
receiving, by the processor, a domain knowledge score for the alert, the domain knowledge score representing a qualitative rating for the abnormal behavior performed by the user as assigned by one or more subject matter experts, the domain knowledge score indicating that the alert represents a positive alert;
determining, by the processor, a machine knowledge score for the alert, the machine knowledge score representing a percent of positive previously closed alerts for the type of abnormal behavior for one or more user accounts other than the user account, the machine knowledge score indicating that the alert represents a false positive alert;
calculating, by the processor, an overall score for the alert from the domain knowledge score and the machine knowledge score, the overall score indicating that the alert represents the positive alert;
preventing, by the processor, the abnormal behavior; and
increasing, by the processor, the percent of positive previously closed alerts for the type of abnormal behavior.

2. The method of claim 1, wherein receiving the alert comprises receiving a plurality of alerts including the alert from a single source, the method further comprising:
calculating respective scores for each of the plurality of alerts using respective domain knowledge scores and respective machine knowledge scores; and
determining a riskiness of the single source using the respective scores.

3. The method of claim 2, wherein the single source comprises one of an employee of a business branch, the business branch, or a region including the business branch.

4. The method of claim 1, wherein calculating the overall score comprises:
determining a domain weight to apply to the domain knowledge score;
determining a machine weight to apply to the machine knowledge score; and
calculating the overall score as a sum of the domain weight multiplied by the domain knowledge score and the machine weight multiplied by the machine knowledge score.

5. The method of claim 4, wherein a sum of the domain weight and the machine weight is equal to 1.

6. The method of claim 4, wherein the domain weight comprises one of 0.11, 0.33, or 1.00.

7. The method of claim 4, wherein the domain weight comprises a value of 0.7 and the machine weight comprises a value of 0.3.

8. The method of claim 4, further comprising adjusting the domain weight and the machine weight to increase the machine weight and decrease the domain weight.

9. The method of claim 1, further comprising outputting data representative of the alert to a user in response to the alert being the positive alert.

10. A device comprising a processor implemented in circuitry and configured to:
receive an alert representing a type of abnormal behavior for a user account, the type of abnormal behavior being a type of behavior performed by a user associated with the user account that is abnormal relative to types of behaviors of other users with respect to respective accounts for the other users;
receive a domain knowledge score for the alert, the domain knowledge score representing a qualitative rating for the abnormal behavior performed by the user as assigned by one or more subject matter experts, the domain knowledge score indicating that the alert represents a positive alert;
determine a machine knowledge score for the alert, the machine knowledge score representing a percent of positive previously closed alerts for the type of abnormal behavior for one or more user accounts other than the user account, the machine knowledge score indicating that the alert represents a false positive alert;
calculate an overall score for the alert from the domain knowledge score and the machine knowledge score, the overall score indicating that the alert represents the positive alert;
prevent the abnormal behavior; and
increase the percent of positive previously closed alerts for the type of abnormal behavior.

11. The device of claim 10, wherein the alert comprises one alert of a plurality of alerts from a single source, and wherein the processor is further configured to:
calculate respective scores for each of the plurality of alerts using respective domain knowledge scores and respective machine knowledge scores; and
determine a riskiness of the single source using the respective scores.

12. The device of claim 11, wherein the single source comprises one of an employee of a business branch, the business branch, or a region including the business branch.

13. The device of claim 10, wherein to calculate the overall score, the processor is configured to:
determine a domain weight to apply to the domain knowledge score;
determine a machine weight to apply to the machine knowledge score; and
calculate the overall score as a sum of the domain weight multiplied by the domain knowledge score and the machine weight multiplied by the machine knowledge score.

14. The device of claim 13, wherein a sum of the domain weight and the machine weight is equal to 1.

15. The device of claim 13, wherein the domain weight comprises one of 0.11, 0.33, or 1.00.

16. The device of claim 13, wherein the domain weight comprises a value of 0.7 and the machine weight comprises a value of 0.3.

17. The device of claim 13, wherein the processor is further configured to adjust the domain weight and the machine weight to increase the machine weight and decrease the domain weight.

18. The device of claim 10, wherein the processor is further configured to output data representative of the alert to a user in response to the alert being the positive alert.

19. A computer-readable storage medium having stored thereon instructions that, when executed, cause a processor to:
receive an alert representing a type of abnormal behavior for a user account, the type of abnormal behavior being a type of behavior performed by a user associated with the user account that is abnormal relative to types of behaviors of other users with respect to respective accounts for the other users;
receive a domain knowledge score for the alert, the domain knowledge score representing a qualitative rating for the abnormal behavior performed by the user as assigned by one or more subject matter experts, the domain knowledge score indicating that the alert represents a positive alert;
determine a machine knowledge score for the alert, the machine knowledge score representing a percent of positive previously closed alerts for the type of abnormal behavior for one or more user accounts other than the user account, the machine knowledge score indicating that the alert represents a false positive alert;
calculate an overall score for the alert from the domain knowledge score and the machine knowledge score, the overall score indicating that the alert represents the positive alert;
prevent the abnormal behavior; and
increase the percent of positive previously closed alerts for the type of abnormal behavior.

20. The computer-readable storage medium of claim 19, wherein the alert comprises one alert of a plurality of alerts from a single source, wherein the single source comprises one of an employee of a business branch, the business branch, or a region including the business branch, further comprising instructions that cause the processor to:
calculate respective scores for each of the plurality of alerts using respective domain knowledge scores and respective machine knowledge scores; and
determine a riskiness of the single source using the respective scores.
